(19) United States
(12) Patent Application Publication
(10) Pub. No.: US 2006/0256554 A1
(43) Pub. Date: Nov. 16, 2006

(54) Light source system and control method of light source system

(75) Inventors: Kuang-Lung Tsai, Taoyuan Hsien (TW); Tom Po, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/412,096

(22) Filed: Apr. 27, 2006

(30) Foreign Application Priority Data
May 13, 2005 (TW) 094115555

(51) Int. Cl. F21V 23/02; F21S 4/00

(52) U.S. Cl. 362/221

(57) ABSTRACT

A light source system includes a light unit, a control unit, a light detector and a determining unit. In this case, the control unit is used to drive the light unit. The light detector is for detecting the brightness of the light unit, and generates a brightness detection signal based on the brightness of the light unit. The determining unit receives the brightness detection signal so as to determine whether the brightness of the light unit is equal to a predetermined value or not. When the brightness of the light unit is not equal to the predetermined value, the determining device then outputs a control signal to the control unit. The control unit generates an adjustment signal based on the control signal so as to adjust the brightness of the light unit.

### BACKGROUND OF THE INVENTION

1. Field of Invention

The invention relates to a light source system and a control method thereof and, in particular, to a light source system for display devices and a control method thereof.

2. Related Art

In view of the multimedia era, the display devices become more versatile than before. In particular, flat display devices become the main products due to that they have light weights and compact sizes. Among such displays, the liquid crystal display (LCD) has the widest applications because that the LCD has full colors, higher dpi, smaller thickness, lower power consumption, and high contrast. The LCD can be applied to the small-dimension mobile phone screens and car display panels, the mid-size notebook computer screens and desktop screens, and the large-size LCD TV. However, the liquid crystal itself cannot emit light. A light source system is required to be the backlight module of the LCD to provide sufficient and uniform brightness.

With reference to FIG. 1, the conventional light source system 1 mainly includes a plurality of light units 11, a current detector 12, and a control unit 13. A common light unit 11 is a cold cathode fluorescent lamp (CCFL). The control unit 13 contains several control chips 131 and several transformers 132 to drive the light units 11. The current detector 12 is used to detect the current of the light unit 11 and compares it with an initial value. When the current is lower or higher than the initial value, the control unit 13 adjusts the voltage on the light unit 11 to change the brightness of the light unit 11.

However, since different light units 11 may have different brightness even driven by the same voltage. This is due to the intrinsic property differences of the light units 11 caused by the manufacturing process and other variables. Aside from those mentioned above, the brightness of the light unit 11 has a natural aging effect. Therefore, even if the light unit 11 is still driven by the same voltage, its brightness decays with time. The current detection method in the prior art cannot accurately determine the brightness of the light units 11. As a result, the brightness of the light units decays with time, which deteriorates the quality of the LCD.

Therefore, it is an important subject to provide a light source system and control method thereof, which can accurately detect and adjust the brightness.

### SUMMARY OF THE INVENTION

In view of the foregoing, the invention is to provide a light source system with accurately adjustable brightness and the control method thereof.

To achieve the above, a light source system of the invention includes a light unit, a control unit, a light detector, and a determining unit. In the invention, the control unit is used to drive the light unit. The light detector detects the brightness of the light unit, and generates a brightness detection signal based on the brightness of the light unit. The determining unit receives the brightness detection signal and determines whether the brightness of the light unit is equal to a predetermined value or not. When the brightness of the light unit is not equal to the predetermined value, the determining device outputs a control signal to the control unit. The control unit generates an adjustment signal based on the control signal so as to adjust the brightness of the light unit.

To achieve the above, the invention also discloses a control method of a light source system for adjusting the brightness of at least one light unit. The control method includes the steps of: detecting the brightness of the light unit; generating a brightness detection signal based on the brightness of the light unit; detecting whether the brightness detection signal is equal to a predetermined value; and outputting an adjustment signal when the brightness detection signal is not equal to the predetermined value.

As mentioned above, the light source system and the control method thereof of the invention directly detect the actual brightness of the light unit and adjust the brightness of the light unit according to the detecting result. Therefore, the brightness of the light unit can be controlled and adjusted accurately, and the quality of the LCD is thus improved.

### BRIEF DESCRIPTION OF THE DRAWINGS

The invention will become more fully understood from the detailed description given herein below illustration only, and thus is not limitative of the present invention, and wherein:

FIG. 1 is a schematic view of a conventional light source system;

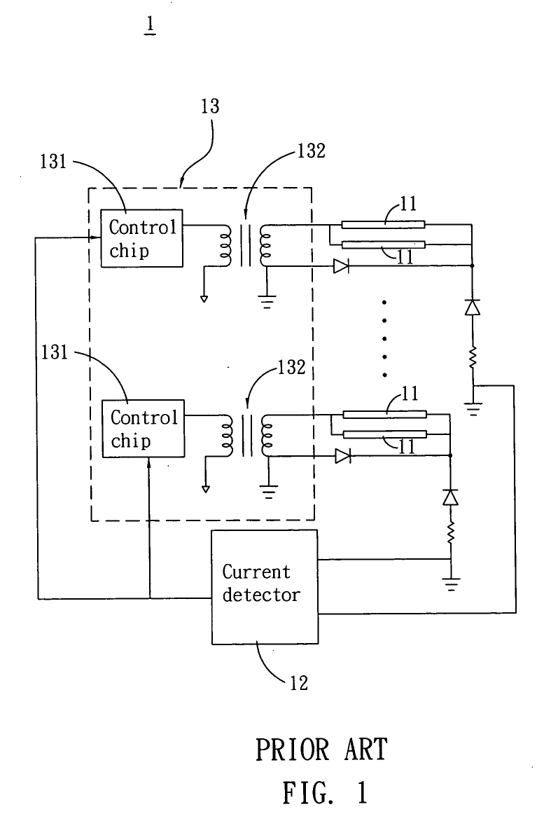

FIG. 2 is a schematic view of the light source system according to an embodiment of the invention;

FIG. 3 is a flowchart of the control method of a light source system according to an embodiment of the invention;

FIG. 4 is a schematic view of the light source system according to another embodiment of the invention;

FIG. 5 is a schematic view of an LCD with the light source system according to the embodiment of the invention; and

FIG. 6 is a schematic view of the light source system according to another embodiment of the invention.

### DETAILED DESCRIPTION OF THE INVENTION

The present invention will be apparent from the following detailed description, which proceeds with reference to the accompanying drawings, wherein the same references relate to the same elements.

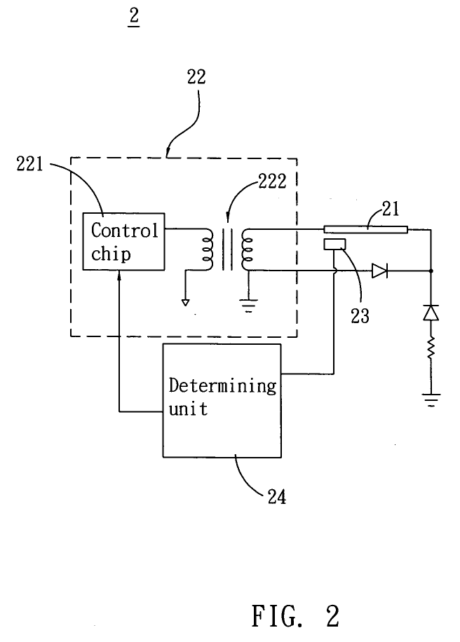

Whit reference to FIG. 2 showing a schematic view of a light source system 2 according to an embodiment of the invention, the light source system 2 comprises a light unit 21, a control unit 22, a light detector 23, and a determining unit 24. The light unit 21 may be a CCFL, a light-emitting diode (LED), or any other type of light unit. The control unit 22 has a control chip 221 and a transformer 222, and can drive the light unit 21.

In this embodiment, the light detector 23 may be a light-detecting diode, a carrier coupler, an optical transistor, a photosensitive resistor, or any other type of light detector. The light detector 23 is used to detect the brightness of the light unit 21 and generates a brightness detection signal accordingly.

Moreover, the determining unit 25 receives the brightness detection signal and determines whether the brightness of the light unit 21 is equal to a predetermined value, which is set according to the practical need as a standard brightness reference value. When the determining unit 25 determines that the brightness detection signal is not equal to the predetermined value, the determining unit 25 outputs a control signal to the control unit 22. The control unit 22 outputs an adjustment signal according to the control signal to adjust the brightness of the light unit 21. The adjustment signal, depending on the need, is a voltage signal or a current signal.

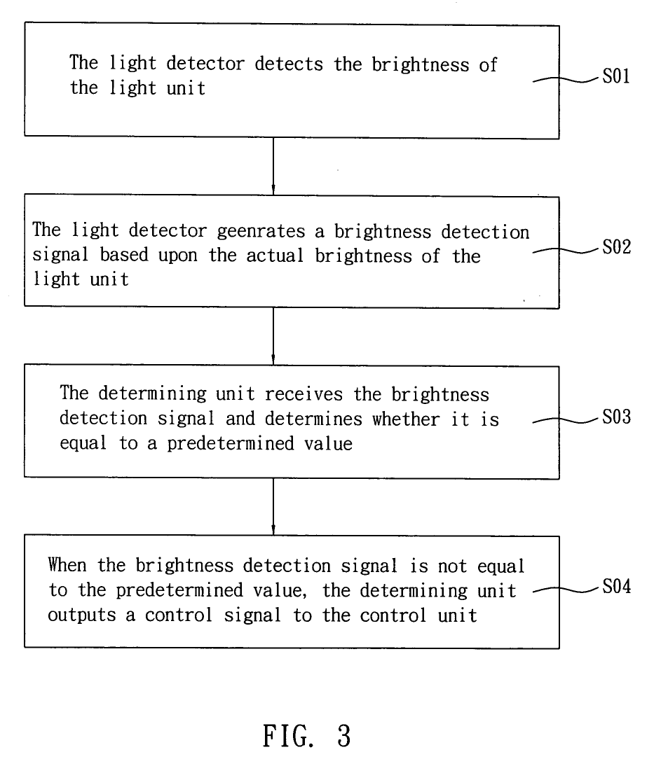

Please refer to FIG. 3 showing a flowchart of the control method of a light source system. This control method can be applied to the above-mentioned light source system 2. The control method of a light source system comprises the following steps.

In step S01, the light detector 23 detects the brightness of the light unit 21.

In step S02, the light detector 23 generates a brightness detection signal based on the actual brightness of the light unit 21.

In step S03, the determining unit 24 receives the brightness detection signal and determines whether it is equal to a predetermined value.

In step S04, when the brightness detection signal is not equal to the predetermined value, the determining unit 24 outputs a control signal to the control unit 22. The control unit 22 outputs an adjustment signal (in the form of a voltage signal or a current signal) based on the control signal so as to drive the light unit. For example, when the brightness detection signal is smaller than the predetermined value, it means the brightness of the light unit 21 is insufficient. In this case, the control unit 22 outputs a larger adjustment signal (voltage signal or current signal) to increase the brightness of the light unit 21. If the brightness detection signal is greater than the predetermined values, it means that the brightness of the light unit 21 is higher. In this case, the control unit 22 outputs a smaller adjustment signal (voltage signal or current signal) to decrease the brightness of the light unit 21. As mentioned above, the light detector 23 directly detects the brightness of the light unit 21 so as to achieve the goal of accurately adjusting the brightness of the light unit 21.

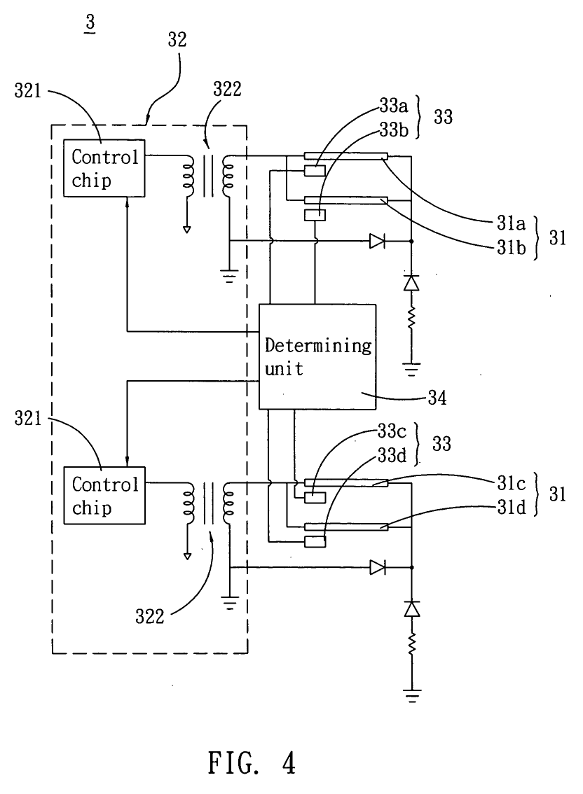

With reference to FIG. 4, a light source system 3 according to another embodiment of the invention comprises a light unit 31, a control unit 32, a light detector 33, and a determining unit 34.

As shown in FIG. 4, the light unit 31 has a plurality of light elements 31a, 31b, 31c, 31d, which may be CCFL or LED. The control unit 32 has control chips 321 and transformers 322 and drives the light elements 31a, 31b, 31c, and 31d.

The light detector 33 has a plurality of light detecting elements 33a, 33b, 33c, 33d corresponding to the light elements 31a, 31b, 31c, 31d, respectively, to detect the brightness of the light elements 31a, 31b, 31c, 31d. The light elements 33a, 33b, 33c, 33d respectively generate corresponding brightness detection signals according to the detected brightness. It should be noted that the number of the light detecting elements needs not to be the same as the number of the light elements. They may have a one-to-one or one-to-many relation.

The determining unit 34 is used to receive the brightness detection signals generated by the light detecting elements 33a, 33b, 33c, 33d and determines whether the brightness of the light elements 31a, 31b, 31c, 31d are in accord with the predetermined value. When any brightness detection signal is not equal to the predetermined value, the determining unit 34 outputs a control signal to the control unit 32. The control unit 32 adjusts the brightness of the corresponding light unit 31a, 31b, 31c, or 31d based on the control signal.

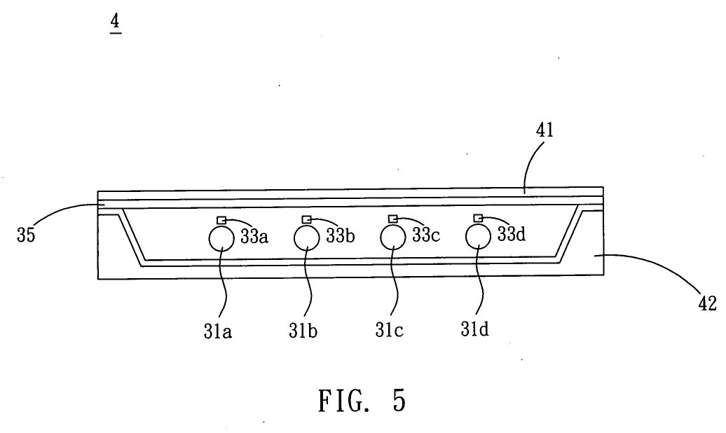

To make the invention more comprehensive, an example using the light source system 3 as the backlight module of an LCD will be described hereinafter. With reference to FIG. 5, the LCD 4 comprises a display panel 41, a shell 42, and a light source system 3. The light source system 3 is provided inside the shell 42 under the display panel 41. The light source system 3 further comprises a diffuser 35 positioned between the display panel 41 and the light elements 31a, 31b, 31c, 31d, and the diffuser 35 can uniformly distribute the light from the light elements 31a, 31b, 31c, 31d to the display panel 41. The light elements 31a, 31b, 31c, 31d are provided inside the shell 42 and disposed in parallel at one side of the diffuser 35. The light detecting elements 33a, 33b, 33c, 33d are disposed respectively above or below the light elements 31a, 31b, 31c, 31d or any positions that can detect the brightness of the light elements 31a, 31b, 31c, 31d. In particular, the light detecting elements 33a, 33b, 33c, and 33d may be disposed at the other side of the diffuser 35.

The functioning principle of the light source system 3 according the preferred embodiment of the invention is as follows. The light detecting elements 33a, 33b, 33c, 33d detect respectively the actual brightness of the light elements 31a, 31b, 31c, and 31d and generate brightness detection signals accordingly. The determining unit 34 receives the brightness detection signals and determines whether they are equal to a predetermined value. When any brightness detection signal is not equal to the predetermined value, the determining unit 34 outputs a control signal to the control unit 32. The control unit 32 drives the corresponding light unit 31a, 31b, 31c, and 31d based on the control signal.

For example, the light element 31b has an insufficient brightness in this example. The light detecting element 33b detects the actual brightness of the light element 31b and generates a corresponding brightness detection signal. Since the light element 31b has an insufficient brightness, its brightness detection signal is smaller than the predetermined value. The determining unit 34 generates a control signal to the control unit 32, so that the control unit 32 increases the voltage or current based on the control signal to the light element 31b. The brightness of the light element 31b is thus increased.

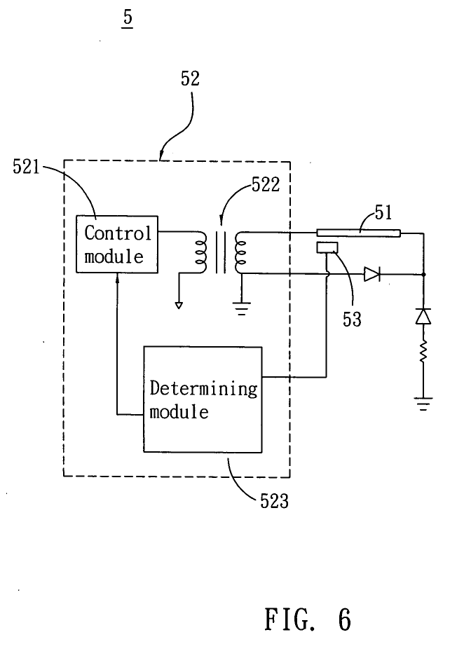

FIG. 6 shows a light source system 5 according to another embodiment of the invention. The light source system 5 comprises a light unit 51, a control unit 52, and a light detector 53. In particular, the light unit 51 may be a CCFL, an LED, or any other type of light unit. The light detector 53 is a light-detecting diode, a carrier coupler, an optical transistor, a photosensitive resistor, or any other type of light detecting element. The light detector 53 is used to detect the brightness of the light unit 51 and generates a corresponding brightness detection signal. The control unit 52 has a control module 521, a transformer 522, and a determining module 523. The control module 521 is used to drive the light unit 21. The determining module 523 determines whether the brightness of the light unit 51 is equal to a predetermined value based on the brightness detection signal. When the determining module 523 determines that the brightness detection signal is not equal to the predetermined value, the control module 521 outputs an adjustment signal to adjust the brightness of the light unit 21. The adjustment signal is a voltage signal or a current signal, depending on the actual need.

The functioning principle of the light source system 5 is as follows. First, the light detector 53 detects the brightness of the light unit 51 and generates a corresponding brightness detection signal according to the actual brightness of the light unit 51. The control unit 52 receives the brightness detection signal and determines whether the brightness detection signal is equal to the predetermined value. When the brightness detection signal is not equal to the predetermined value, the control unit 52 outputs an adjustment signal to adjust the light unit. By directly detecting the brightness of the light unit 51 using the light detector 53, the invention can accurately adjust the brightness of the light unit 51.

In summary, the light source system and the control method of the invention utilize the light detector to directly detect the actual brightness of the light unit. When the brightness of the light unit is not equal to the predetermined value, the determining unit outputs a control signal to the control unit. The control unit outputs an adjustment signal based on the control signal to drive/adjust the brightness of the light unit. In comparison with the prior art, the light source system and the control method of the invention directly detect the actual brightness of the light unit and then adjust it. Thus, the brightness of the light unit can be adjusted accurately. In other words, the invention can avoid the problem of a decreasing brightness as a result of the aging effect. Moreover, the quality of the LCD is thus improved.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A light source system, comprising:
a light unit;
a light detector detecting the brightness of the light unit and generating a brightness detection signal based on the detected brightness of the light unit; and
a control unit receiving the brightness detection signal and adjusting the brightness of the light unit.

2. The light source system of claim 1, wherein the light source system is applied to a display device.

3. The light source system of claim 1, wherein the light unit is a cold cathode fluorescent lamp (CCFL) or a light-emitting diode (LED).

4. The light source system of claim 1, wherein the light detector is a light-detecting diode, a carrier coupler, an optical transistor, or a photosensitive resistor.

5. The light source system of claim 1, wherein the light unit comprises a plurality of light elements and the light detector detects the brightness of the light elements.

6. The light source system of claim 5, wherein the light detector comprises a plurality of light detecting elements, and each of the light detecting elements detects corresponding one of the light elements.

7. The light source system of claim 1, wherein the light unit comprises a light diffuser and at least one light element, and the light element is disposed at one side of the light diffuser.

8. The light source system of claim 7, wherein the light detector is disposed at the other side of the light diffuser to detect the brightness of the light unit.

9. The light source system of claim 1, wherein the control unit comprises a control module, a transformer and a determining module determining whether the brightness of the light unit is equal to the predetermined value or not, and outputs a control signal to the control unit for adjusting the brightness of the light unit.

10. The light source system of claim 1, further comprising a determining module for determining whether the brightness of the light unit is equal to the predetermined value or not, and outputting a control signal to the control unit for adjusting the brightness of the light unit, wherein the control module outputs an adjustment signal to adjust the brightness of the light unit.

11. The light source system of claim 10, wherein the adjustment signal is a voltage signal or a current signal.

12. The light source system of claim 1, wherein the control unit comprises a control chip and a transformer.

13. A control method of a light source system, comprising the steps of:
detecting the brightness of at least one light unit; and
adjusting the brightness of the light unit based on the detected brightness.

14. The control method of claim 13, wherein the step of adjusting the brightness of the light unit based on the detected brightness is to adjust a current or voltage of the light unit so as to adjust the brightness of the light unit.

15. The control method of claim 13, wherein the brightness of the light unit is adjusted to a predetermined value.

16. The control method of claim 13, wherein the step of detecting the brightness of the light unit is to utilize a light detector to detect the brightness of the light unit.

17. The control method of claim 16, wherein the light detector is a light-detecting diode, a carrier coupler, an optical transistor, or a photosensitive resistor.

18. The control method of claim 13, wherein the light unit is a cold cathode fluorescent lamp (CCFL) or a light-emitting diode (LED).

19. The control method of claim 13, wherein the step of adjusting the brightness of the light unit based on the detected brightness comprises the steps of:
generating a brightness detection signal based on the brightness of the light unit;
determining whether the brightness detection signal is equal to a predetermined value; and
outputting an adjustment signal to adjust the brightness of the light unit.
